(19) United States
(12) Patent Application Publication
(10) Pub. No.: US 2015/0113557 A1
(43) Pub. Date: Apr. 23, 2015

(54) DISPLAY DEVICE AND METHOD FOR PROCESSING INFORMATION CODE IN IMAGE

(71) Applicant: Samsung Electronics Co., Ltd., Suwon-si (KR)

(72) Inventors: Keun-seob KIM, Bucheon-si (KR); Deok-jin KIM, Ulsan (KR); Seung-soo LEE, Seoul (KR)

(21) Appl. No.: 14/300,596

(22) Filed: Jun. 10, 2014

(30) Foreign Application Priority Data
Oct. 23, 2013 (KR) 10-2013-0126583

(51) Int. Cl. H04N 21/858; H04N 21/81; H04N 21/436; H04N 21/435; H04N 21/41; H04N 21/44

(52) U.S. Cl. CPC H04N 21/858; H04N 21/4126; H04N 21/44008; H04N 21/43615; H04N 21/435; H04N 21/812; H04N 21/8133; H04N 21/8586
USPC 725/32

(57) ABSTRACT

A display device for processing an information code included in an image is provided. The display device includes an image receiver configured to receive an image signal including an information code, a communicator configured to communicate data with an external device, a display configured to display an image, and a controller configured to capture a still image from the image signal processed to be displayed on the display, to detect the information code from the captured still image, to discover the external device to which information about the recognized information code will be transmitted, and to control the communicator to transmit the information about the information code to the discovered external device.

### CROSS-REFERENCE TO RELATED APPLICATION(S)

This application claims the benefit from a Korean patent application filed on Oct. 23, 2013 in the Korean Intellectual Property Office and assigned Serial number 10-2013-0126583, the entire disclosure of which is hereby incorporated by reference.

### TECHNICAL FIELD

The present disclosure relates to apparatuses and methods consistent with the various embodiments relate to a display device and method for processing an information code included in an image. More particularly, the present disclosure relates to a method and a display device for acquiring information about an information code included in an image and transmitting the acquired information to a user device so that a user can easily view the acquired information.

### BACKGROUND

In recent TeleVision (TV) broadcasting, there have been increasing cases of outputting a Quick Response (QR) code involving information at a certain position on a screen of TV contents in order to provide more detailed information to a TV viewer. However, a viewer may have difficulty approaching the TV so as to make smart phone of the user recognize the corresponding QR code.

Korean Patent Publication No. 2012-0137526 discloses a method and system for providing information through screen scanning In this related art, if a user wants to receive information related to a certain scene of contents while viewing the contents, the user scans the corresponding scene through a user terminal with a camera or the like photographing device. Thereafter, the user terminal transmits the corresponding scene to a server having information about code data such as a barcode, a QR code, and/or the like included in a frame of the scanned scene. The user terminal receives matching information from the server, thereby receiving the information related to the scanned scene.

According to the related art, a method of providing the information related to the contents of the scene output to the TV screen scanned by the user terminal is provided. According to the method, if the scene output to the TV screen is scanned by the user terminal, data is acquired by analyzing frames making up the corresponding scene so that a user can be provided with the related information. However, the method proposed by the related art is achieved on condition that a user is required to directly scan the corresponding scene through the user terminal with the camera or the like photographing device in order to acquire the information about the scene output to the TV screen.

In general, a user is positioned at a distance (e.g., sits away) from the TV, and contents output on the TV are also very quickly altered. Therefore, the foregoing related art is inefficient because the related art requires a user to quickly rise from the user's seat, to take out the user terminal, and to scan the TV screen before a desired scene shifts. In addition, the method according to the related art has a problem that the purpose itself of providing information desired by a user is not accomplished.

Japanese Patent Publication No. 2003-333443 describes a technique according to which a broadcasting receiver of receiving broadcasting content information and appendix information embeds information to be provided to a viewer in the appendix information and transmits the information to a portable device of the viewer. However, this technique does not disclose any method of providing information about a visual code involved in an image to a viewer.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method where a TV periodically reads a visual code presented in a certain region on a screen and transmits information embedded in the corresponding code to an external device located in a neighboring local network, when a contents provider for the TV displays a visual code including the information in the certain region of TV contents in order to make a user's participation or provide a user with more detailed descriptions of the corresponding screen.

In accordance with an aspect of the present disclosure, a display device is provided. The display device includes an image receiver configured to receive an image signal including an information code, a communicator configured to communicate with an external device, a display configured to display an image, and a controller configured to capture a still image from the image signal processed to be displayed on the display, to detect the information code from the captured still image, to discover the external device to which information about the recognized information code will be transmitted, and to control the communicator to transmit the information about the information code to the discovered external device.

In accordance with an aspect of the present disclosure, the controller periodically may capture the still image from the processed image signal.

In accordance with an aspect of the present disclosure, the controller may detect the information code by sequentially scanning the captured still image.

In accordance with an aspect of the present disclosure, the information code may comprise at least one of a Quick Response (QR) code, a barcode and a watermark.

In accordance with an aspect of the present disclosure, the external device may comprise at least one of a smart phone, a game-console controller, a remote controller, a tablet computer, and a personal digital assistant.

In accordance with an aspect of the present disclosure, the information about the information code may comprise at least one of a Uniform Resource Locator (URL), a text message, a phone number, an external-device control signal and an external-device key setting command.

In accordance with an aspect of the present disclosure, the controller may transmit a push message to the discovered external device.

In accordance with another aspect of the present disclosure, a method of processing an information code included in an image of a display device is provided. The method includes receiving an image signal including the information code, processing the received image signal to be displayed on the display device; capturing a still image from the processed image signal, detecting the information code from the captured still image, discovering an external device to which information about the recognized information code will be transmitted, and transmitting the information about the information code to the discovered external device.

In accordance with another aspect of the present disclosure, a method of processing an information code included in an image of a display device is provided. The method includes receiving, by the display device, an image signal including the information code, detecting, by the display device, the information code included in the image signal, determining, by the display device, whether to transmit information relating to the information code to an external device according to at least one of a connectivity of the external device, capability of the external device, and identification of the external device, and transmitting the information relating to the information code to the external device if the display device determines to transmit the information relating to the information code to the external device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 schematically shows a system in which a display device recognizes and transmits an information code according to an embodiment of the present disclosure.

FIG. 2 is a block diagram of a display device according to an embodiment of the present disclosure.

FIG. 3 is a flowchart of processing an information code in a display device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Terms as used in the present disclosure are used to describe the various embodiments of the present disclosure, and are not intended to limit the present disclosure. Singular terms are intended to include plural forms, unless the context makes it clear that plural forms are not intended.

Unless defined differently, all terms used in the present disclosure, including technical or scientific terms, have meanings that are understood generally by a person having ordinary skill in the art. Ordinary terms that may be defined in a dictionary should be understood to have the meaning consistent with their context, and unless clearly defined in the present disclosure, should not be interpreted to be excessively idealistic or formalistic.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

According to various embodiments of the present disclosure, an advertiser may embed an image about the advertiser's goods in an image to be displayed on the display device in order to advertise the goods. However, the image about the goods may not sufficiently inform a viewer of information about the goods, and therefore an information code involving the information about the goods may be embedded in the image.

The information code refers to a Quick Response (QR) code, a barcode, a watermark, and/or the like code given in a certain decodable meaning form. The information code may be produced by patterning contents of certain information in accordance with defined rules. The certain information can be decoded by a pattern analysis. For example, the information of the information code may be information acquired by the TV from analyzing the information embedded in the information code displayed on the TV screen, which includes advertisement information of goods, price information of goods, shop information of goods, Uniform Resource Locator (URL) at which related information is linked, address information of a restaurant, information about a user business card, or the like variety of information a viewer needs. Below, the QR code will be described as an example of the information code.

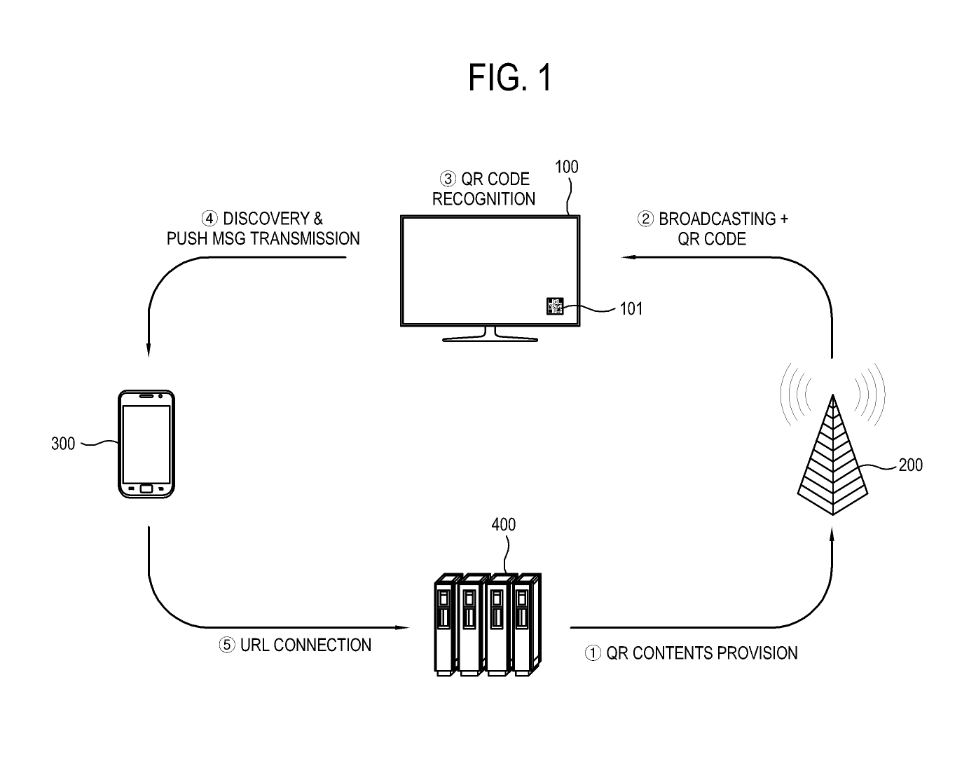

FIG. 1 schematically shows a system in which a display device recognizes and transmits an information code according to an embodiment of the present disclosure.

Referring to FIG. 1, an advertiser (e.g., an image producer) may store information about goods to be displayed on an image in the server 400. For example, the advertiser may store information about goods to be displayed on the image in the server 400 when the image to be displayed by the display device 100 is produced. According to various embodiments of the present disclosure, the advertiser may embed a QR code in the image. According to various embodiments of the present disclosure, the QR code may include a variety of information such as an address (URL) of the server 400, an address of a goods manufacturer, and/or the like. For example, the image produced as above may be broadcasted to a viewer's display device 100 via a broadcasting station, and/or the like image source 200. The image may include a plurality of frames corresponding to still images, and the QR code may be embedded in a certain frame (e.g., in a preset frame of the plurality of frames). According to various embodiments of the present disclosure, the QR code may be embedded in all frames of an image while the image about a corresponding product is displayed. The image made up of these plural frames may be encoded and supplied to a viewer's display device 100 via an airwave or a network.

The display device 100 may receive recorded broadcasting contents, real-time broadcasting contents, and/or the like from a broadcasting station, or may receive previously produced contents from the server 400. The previously produced contents may include Video on Demand (VoD) contents, premium VoD contents, broadcasting contents, Internet contents, a local file, external contents connected through a Digital Living Network Alliance (DLNA) network, and/or the like. For example, the server 400 may be achieved by a server providing the VoD contents, and by downloading VoD contents, or by providing VOD contents in the form of streaming Therefore, the server 400 may have a database of various multimedia contents. However, the contents may be received by communicating with a separate data providing server (not shown) as necessary.

In addition, the display device 100 may receive contents being reproduced by an external content reproducer (not shown). The external content reproducer may include various electronic devices capable of reproducing contents, such as a Digital Versatile Disc (DVD), a mobile phone, an MP3 player, and/or the like. However, the contents are not limited to the moving image contents, but may include any contents such as a photograph, a still image and/or the like contents that are displayable.

The display device 100 captures a still image including the QR code from the received the image contents, and detects and analyzes the QR code embedded in the still image. According to various embodiments of the present disclosure, the display device 100 may periodically capture the still image and detect the QR code regardless of operations of a viewer. The display device 100 discovers an external device 300 to which information resulting from analyzing the QR code will be sent, and sends the information of the QR code to the discovered external device 300. According to various embodiments of the present disclosure, the display device 100 may transmit a push message to the discovered external device 300 and confirm whether the external device 300 will receive the information. The external device 300 may previously implement an application needed for receiving the certain information.

The display device 100 may send various data such as URL of the server, product information, a command for implementing a certain client application, a text message, call information, a command for controlling operations of the application, and/or the like to the searched external device 300.

According to various embodiments of the present disclosure, the external device 300 may be an electronic device such as a smartphone, a tablet PC, a mobile phone, and/or the like.

The external device 300 may acquire necessary information by accessing the server 400 of an advertiser through the received information (e.g., URL) of the QR code. According to various embodiments of the present disclosure, the QR code includes the URL information. However, various embodiments of the present disclosure not limited thereto. Alternatively, a variety of information may be employed as necessary. For example, a phone call may be made or a text message may be automatically sent through a phone number of a goods vendor.

The display device 100 may be implemented as or operatively connected to an electronic device such as a TV, a set-top box, a mobile phone, a PC, a notebook computer, a PDA, a tablet PC, a game console, and/or the like that can display or reproduce the contents or have a function of reproducing the contents. Alternatively, the display device 100 may have only a function of receiving and displaying the contents reproduced by a separate contents-reproducing device (not shown).

As an example, if the display device 100 is a TV, the display device 100 may be an Internet Protocol TeleVision (IPTV). The IPTV is an interactive TV service provided through high-speed Internet, which may be achieved in the form of connecting the TV with the server 400 via the set-top box through Internet.

In addition, the external device 300 may include an electronic device such as a smart phone, a game console, a remote controller, a PDA, and/or the like.

The image source 200 may include an airwave broadcasting station, a cable broadcasting station, a satellite broadcasting station, an Internet contents provider, and/or the like.

As illustrated in FIG. 1, at operation 1, the server 400 provides the information about the goods to be displayed to the image source 200.

At operation 2, the image source 200 communicates an information signal (e.g., an image signal) and the information about the goods to a display device 100. The information signal and the information about the goods may be multiplexed into a signal.

At operation 3, the display device 100 detects and recognizes the information about the goods from the signal received.

At operation 4, the display device 100 performs a discovery for an external device 300, and transmits a push message to a discovered external device. The push message includes information relating to the detected information about the goods.

At operation 5, the external device 300 performs a corresponding function. For example, the external device 300 performs a function according to the information relating to the goods included in push message received from the display device 100. As an example, the external device 300 may perform a URL connection.

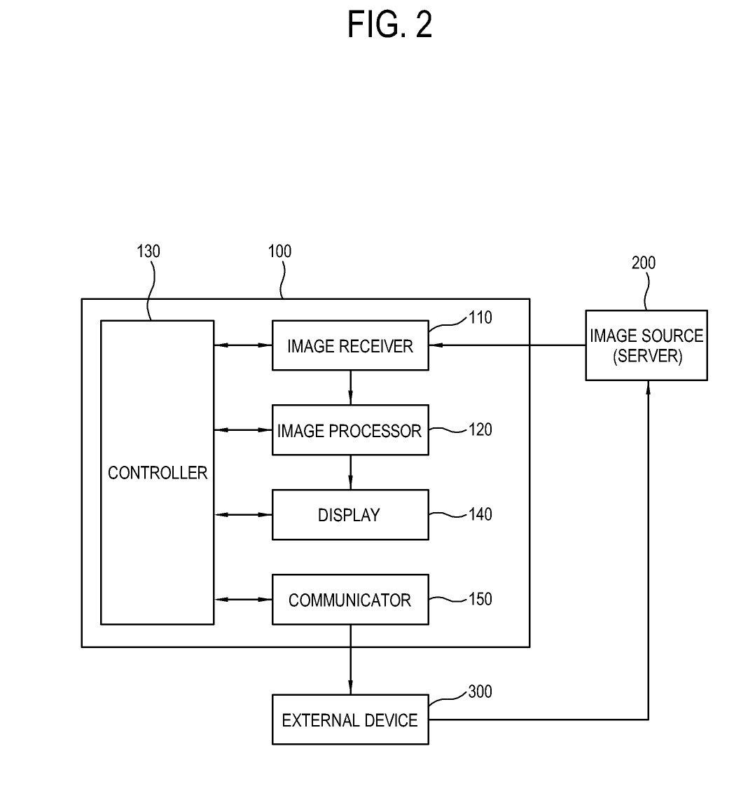

FIG. 2 is a block diagram of a display device according to an embodiment of the present disclosure.

Referring to FIG. 2, the display device 100 may include an image receiver 110, an image processor 120, a controller 130, a display 140, and a communicator 150.

The image receiver 110 may be configured to receive an image from an external image source 200. The image processor 120 may be configured to process the received image to be displayable. The display 140 configured to display the processed image. The communicator 150 may be configured to communicate with the external device 300. The controller 130 may be configured to controls the elements of the display device 100 (e.g., the image receiver 110, the image processor 120, the display 140, the communicator 150, and/or the like).

The image receiver 110 may receive an image signal from the image source (e.g., a broadcasting station, and/or the like). The received image signal may include the information code involving a variety of information (e.g., the QR code), as a part of the image. For example, the image displayed on the display device 100 may include a product image, and the product image may include information related to a product to be advertised by an advertiser (e.g., URL, a phone number, an address, text information, and/or the like).

The image receiver 110 may receive a Radio Frequency (RF) signal from the broadcasting station wirelessly, or may receive an image signal complying with standards such as composite video, component video, super video, Syndicat des Constructeurs des Appareils Radiorécepteurs et Téléviseurs (SCART), High Definition Multimedia Interface (HDMI), and/or the like. According to various embodiments of the present disclosure, the image receiver 110 may further include an antenna (not shown) and/or a tuner (not shown) for selecting a broadcasting channel.

In addition, the image receiver 110 may be achieved by D-SUBminiature (D-SUB) for transmitting Red, Green and Blue (RGB) signals complying with VGA standards; Digital Video Interactive-Analog (DVI-A), Digital Video Interactive-Integrated digital/analog (DVI-I) and Digital Video Interactive-Digital (DVI-D) complying with DVI standards; HDMI standards, and/or the like. Further, the image receiver 110 may be achieved by a display port, a Unified Display Interface (UDI), a wireless HD, and/or the like.

The image processor 120 may perform various preset imaging processes adapted to display the received image signal. There is no limit to the kind of imaging processes. For example, there are scaling for magnifying or reducing the screen in accordance with given resolutions, decoding and encoding corresponding to various image formats, de-interlacing, frame refresh rate conversion, noise reduction for improving image qualities, detail enhancement, line scanning, and/or the like. The processor may be individually or collectively performed.

The display 140 may display an image processed by the image processor 120 so that a viewer can see the image. For example, display 140 may display one still image by vertically arranging a plurality of scanned horizontal scan lines. The display 140 includes a display panel (not shown) for displaying the image, and the display panel (not shown) may include a liquid crystal display panel having an liquid crystal layer, an organic light emitting panel having an organic emission layer, a plasma display panel, and/or the like. According to various embodiments of the present disclosure, the display 140 may include a flexible panel.

The controller 130 may control the elements of the display device 100 (e.g., the image receiver 110, the image processor 120, the display 140 and the communicator 150, and/or the like).

The controller 130 may perform the operations of capturing a still image from the received image signal processed to be displayed on the display 140, detecting and recognizing the information code from the captured still image, recovering the external device 300 to which information of the recognized information code will be sent, and sending the code information to the discovered external device 300 through the communicator 150.

The controller 130 may include Application Specific Integrated Circuits (ASICs), Digital Signal Processors (DSPs), Digital Signal Processing Devices (DSPDs), Programmable Logic Devices (PLDs), Field Programmable Gate Arrays (FPGAs), micro-controllers, microprocessors, and/or the like.

Various operations of the controller 130 according to various embodiments of the present disclosure will be described in detail as follows.

The operation of the controller 130 to capture the still image may be performed by capturing the still image at a certain point of time with regard to each still image frame of the plurality of frames processed in the image processor 120. The function of capturing the still image with regard to the displayed image may be periodically performed. The moving image displayed on the display device 100 may be achieved by displaying 30 or more frames per second. According to various embodiments of the present disclosure, if an image of a certain product is displayed for 3 minutes and 30 frames are displayed per second, only one still image among 5,400 still images is enough to detect the QR code of the corresponding product.

The function of the controller 130 to recognize the information code may acquire pattern information of a QR code 101 included in the still image by sequentially scanning the captured still image. According to various embodiments of the present disclosure, the QR code 101 is generally arranged in a corner or an outward portion, and therefore the scanning may be performed from the outward portion. To recognize the information code, the still image is scanned to read a pattern of the QR code and thus information embedded in the QR code 101 (e.g., URL information) is acquired. The recognition of the information code may be performed by applying software such as a QR pattern recognition application, which can be installed in an Android Operating System (OS), an Apple OS, a Microsoft OS, and/or the like to the captured still image. According to various embodiments of the present disclosure, the QR code 101 may be included in a preset location of the still image and the controller 130 may acquire pattern information of the QR code 101 by scanning the preset location of the still image.

The operation of the controller 130 to discover the external device may perform a local device discovery to discover the external device 300 to which the recognized QR code information may be sent.

According to various embodiments of the present disclosure, the local device discovery is performed by discovering neighboring external devices 300 through Wi-Fi, Bluetooth, and/or the like wireless communication, and connecting to the discovered external device 300. In the following example, various embodiments of the present disclosure relating to the Wi-Fi-based discovery will be described. As an example, a purpose of the discovery is to find the external devices 300 and connect with the external devices 300 as quick as possible. The discovery includes a device discovery and a provision discovery.

The device discovery broadly includes two stages (e.g., a scanning stage and a finding stage). The device discovery uses a probe request frame and a probe response frame to exchange information between the devices. If the external device 300 is an owner of a group or is in a listening state, the external device 300 can respond to the probe request frame received from the display device 100. If the external device 300 does not belong to the group, the external device 300 can be in the listening state. For example, the external device 300 responds to the probe request frame in the listening state.

In the device discovery, as an example, a purpose of the scanning stage may be to find an external device or a group of external devices. As an example, a purpose of the scanning stage may be to find a channel most appropriate to set up the group of external devices. For example, in the scanning stage, the external device scans all the supported channels and collects information from a neighboring device or network. In the scanning stage, the external device may not respond to the probe request frame.

In the finding stage of the device discovery, the external devices of one channel transmit and receive a message and find each other. In the listening state, the external device waits for receiving the probe request frame. If the probe request frame is received, the external device transmits a probe response frame to the other party (e.g., the display device 100). The probe response frame may include information such as a device name, a device address of an external device, vendor information, and/or the like. In particular, if the external device is a device supporting mobile communication (e.g., a smart phone), the probe response frame may further include a phone number. In addition, the probe response frame may further include a user IDentification (ID) information of the corresponding external device. Such a user ID information may include a user name, a photograph, and/or the like. The other party (e.g., the display device 100) that receives the probe response frame may display the foregoing information included in the probe response frame so as to be confirmed by a user.

The display device 100 and the external device 300 discovering each other through the device discovery can be connected to each other.

First, the display device 100 performs the provision discovery with respect to the other party (e.g., the external device 300) desired for the connection. The provision discovery informs a user that the display device 100 tries to connect to the other party (e.g., the external device 300) through a Push Button Configuration (PBC) mode or a Personal Identification Number (PIN) mode of Wi-Fi Simple Configuration (WSC), when the display device 100 tries the connection. The external device 300 receives a provision discovery request frame for the provision discovery, and informs a user of contents through a popup message, and/or the like. As an example, the popup message (e.g., informing the user of the provision discovery) may include information about the display device 100 requesting the provision discovery, such as a device name, and/or the like information. A user of the external device 300, which receives the request, determines whether to accept the connection, determine WSC, and/or the like. For example, the external device 300 that receives the request may prompt a user thereof for indication as to whether to accept the connection, and/or the like.

The external device 300 transmits a provision discovery response frame to the display device 100 in order to inform the display device 100 whether the connection is accepted, and/or the like.

The communicator 150 may perform data communication, short-range wired/wireless communication, and/or the like with a server, a mobile device, a remote controller, and/or the like external devices. The communicator 150 may employ data communication such as Very high bit rate Digital Subscriber Line (VDSL), Ethernet, token ring, High Definition Multimedia Interface (HDMI), Universal Serial Bus (USB), Component, Low Voltage Differential Signaling (LVDS), Header Error Control (HEC), and/or the like. The communicator 150 may employ mobile communication such as 2G, 3G, 4G, Long Term Evolution (LTE), and/or the like. The communicator 150 may employ wireless Internet technology such as Wireless Local Area Network (WLAN, Wi-Fi), Wireless Broadband (WiBro), World Interoperability for Microwave Access (WiMAX), high speed downlink packet access (HSDPA), and/or the like. The communicator 150 may employ short-range communication technology such as Bluetooth, Radio Frequency IDentification (RFID), Infrared Data Association (IrDA,), Ultra WideBand (UWB), ZigBee, and/or the like. The communicator 150 may employ other communication technologies.

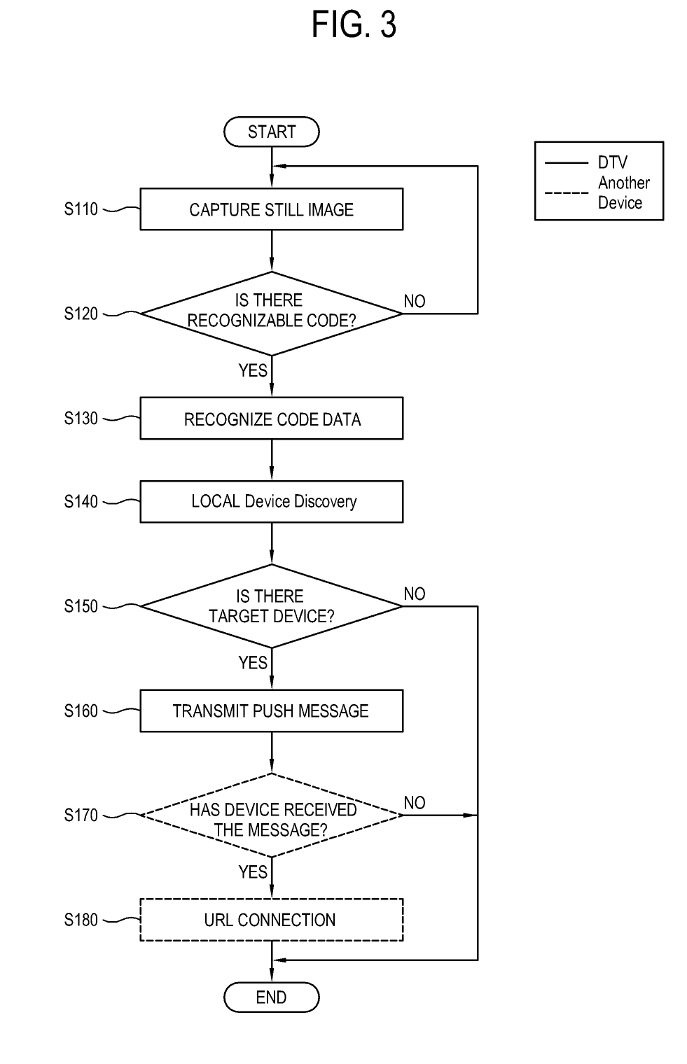

A method of processing the information code embedded in the image signal displayed on the display device 100 according to various embodiments of the present disclosure will be described in detail with reference to FIG. 3.

FIG. 3 is a flowchart of processing an information code in a display device according to an embodiment of the present disclosure.

Referring to FIG. 3, at operation S110, the image processor 120 of the display device 100 processes the received image signal including the QR code to be displayed on the display 140, and the controller 130 captures the still image from the processed image. According to various embodiments of the present disclosure, the still image may be periodically captured.

At operation S120, the controller 130 scans the captured still image and determine whether a recognizable code exists.

According to various embodiments of the present disclosure, if the controller 130 determines that the captured still image does not include a recognizable code at operation S120, the still image is captured again in the next period (e.g., the controller 130 proceeds to operation S110).

In contrast, if the controller 130 determines that the captured still image includes a recognizable code at operation S120, then the controller 130 proceeds to operation S130 at which the controller 130 recognizes the information of the corresponding information code.

At operation S140, the controller 130 performs the local device discovery to discover the external device 300 to which the information of the recognized QR code will be sent.

At operation S150, the controller 130 determines whether a target device exists. For example, the controller 130 determines whether a target device exists based on results of the local device discovery at operation S140.

If the controller 130 determines that a target device does not exist at operation S150, then the controller 130 terminates the method for processing the information code. For example, the controller 130 terminates the method for processing the information code if the controller 130 determines that no external device exists as a result of discovering the external device.

In contrast, if the controller 130 determines that a target device exists at operation S150, then the controller 130 proceeds to operation S160 at which the controller 130 transmits a push message. For example, if the controller 130 determines that an external device exists as a result of discovering the external device, the controller 130 transmits a push message to the target external device 300.

At operation S170, the external device 300 determines whether the external device 300 has received the message (e.g., the push message transmitted by the controller 13). According to various embodiments of the present disclosure, a user of the external device 300 determines whether to receive the information sent from the display device 100, based on the received push message. If a user does not accept the reception, the external device 300 terminates.

If the external device 300 determines that the device has not received the message at operation S170, then the method for processing the information code may terminate. As another example, if the user of the external device 300 selects to not accept the information sent from the display device 100, then the method for processing the information code may terminate.

In contrast, if the external device 300 determines that the device has received the message operation S170 (e.g., if a user of the external device 300 accepts the reception of the information), then the controller 130 may proceed to operation S180 at which the external device 300 displays the corresponding information and/or automatically connects to URL. According to various embodiments of the present disclosure, the operations of the external device 300 may be varied depending on the received information. If the external device 300 is a smart phone, the received information may be a text message, a phone number, URL, and/or the like. If the external device 300 is a game-console controller, the received information may be a signal for setting up control keys of the game-console controller.

According to various embodiments of the present disclosure, the external device 300 may be previously installed with an application implemented for automatically performing a certain work in accordance with information received from the display device 100. For example, if a phone number or a text message is received, the external device 300 may implement a calling or messaging application to automatically make a phone call or send a message.

According to various embodiments of the present disclosure, the external device 300 may operate in accordance with a control signal (e.g., for controlling hardware or software of the external device 300), received from the display device 100.

According to various embodiments of the present disclosure, when information intended by a contents provider is viewed through a TV, a user device present in a local network may be found and the information may be sent to the user device, so that the user can easily answer a questionnaire, cast a vote, participate in an event, and/or the like as intended by the TV contents provider and check (e.g., determine) additional information involved in a screen on the spot while not going near to the TV screen and scanning the corresponding information but just viewing the TV.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made without departing from the scope and scope of the present disclosure as defined by the appended claims and their equivalents.

What is claimed is:

1. A display device comprising:
an image receiver configured to receive an image signal including an information code;
a communicator configured to communicate data with an external device;
a display configured to display an image; and
a controller configured to capture a still image from the image signal processed to be displayed on the display, to detect the information code from the captured still image, to discover the external device to which information about the recognized information code will be transmitted, and to control the communicator to transmit the information about the information code to the discovered external device.

2. The display device according to claim 1, wherein the controller periodically captures the still image from the processed image signal.

3. The display device according to claim 1, wherein the controller detects the information code by sequentially scanning the captured still image.

4. The display device according to claim 1, wherein the information code comprises at least one of a Quick Response (QR) code, a barcode, and a watermark.

5. The display device according to claim 1, wherein the external device comprises at least one of a smart phone, a game-console controller, a remote controller, a tablet computer, and a personal digital assistant.

6. The display device according to claim 1, wherein the information about the information code comprises at least one of a Uniform Resource Locator (URL), a text message, a phone number, an external-device control signal, and an external-device key setting command.

7. The display device according to claim 1, wherein the controller transmits a push message to the discovered external device.

8. A method of processing an information code included in an image of a display device, the method comprising:
receiving an image signal including the information code;
processing the received image signal to be displayed on the display device;
capturing a still image from the processed image signal;
detecting the information code from the captured still image;
discovering an external device to which information about the recognized information code will be transmitted; and
transmitting the information about the information code to the discovered external device.

9. The method according to claim 8, wherein the capturing of the still image comprises:
periodically capturing the still image from the processed image signal

10. The method according to claim 8, wherein the detecting of the information code comprises:
detecting the information code by sequentially scanning the captured still image.

11. The method according to claim 8, wherein the information code comprises at least one of a QR code, a barcode, and a watermark.

12. The method according to claim 8, wherein the external device comprises at least one of a smart phone, a game-console controller, a remote controller, a tablet computer, and a personal digital assistant.

13. The method according to claim 8, wherein the information about the information code comprises at least one of a uniform resource locator (URL), a text message, a phone number, an external-device control signal, and an external-device key setting command.

14. The method according to claim 8, further comprising:
transmitting a push message to the discovered external device.

15. The method according to claim 8, further comprising:
previously implementing, by the external device, an application related to the information about the information code.

16. The method according to claim 8, further comprising:
automatically implementing, by the external device, an application, based on the received information about the information code.

17. The method according to claim 8, further comprising:
setting, by the external device, a control key for controlling the display device, based on the received information about the information code.

18. The method according to claim 8, further comprising:
setting, by the external device, a control key for controlling an application of the display device, based on the received information about the information code.

19. A non-transitory computer-readable storage medium storing instructions, that, when executed, cause at least one processor to perform the method of claim 1.

20. A method of processing an information code included in an image of a display device, the method comprising:
receiving, by the display device, an image signal including the information code;
detecting, by the display device, the information code included in the image signal;
determining, by the display device, whether to transmit information relating to the information code to an external device according to at least one of a connectivity of the external device, capability of the external device, and identification of the external device; and
transmitting the information relating to the information code to the external device if the display device determines to transmit the information relating to the information code to the external device.
